(19) United States
(12) Patent Application Publication
(10) Pub. No.: US 2011/0230576 A1
(43) Pub. Date: Sep. 22, 2011

(54) FOAMABLE RESIN COMPOSITION AND FOAMED BODY

(75) Inventors: Kei Takahashi, Minato-ku (JP); Terumitsu Kotani, Minato-ku (JP); Haruki Nishiike, Minato-ku (JP); Hiroshi Kani, Sapporo-shi (JP); Katsumi Konno, Sapporo-shi (JP)

(73) Assignees: SHOWA HIGHPOLYMER CO., LTD., Minato-ku, Tokyo (JP); HOKKAIDO GOVERNMENT, Sapporo-shi, Hokkaido (JP)

(21) Appl. No.: 12/808,976

(22) PCT Filed: Dec. 9, 2008
(86) PCT No.: PCT/JP2008/072312

§ 371 Date: Jun. 17, 2010

(30) Foreign Application Priority Data
Dec. 19, 2007 (JP) 2007-326794

(51) Int. Cl. C08J 9/35; C08L 3/02; C08L 67/00

(52) U.S. Cl. 521/84.1

(57) ABSTRACT

A foamable resin composition according to the present invention comprises starch, an aliphatic polyester and water, and wherein 10 to 40 parts by mass of the water and 10 to 80 parts by mass of the aliphatic polyester are included with respect to 100 parts by mass of the starch. The foamable resin composition preferably comprises 3 to 60 parts by mass of a glycerin with respect to 100 parts by mass of the starch. The whole composition of the foamable resin composition is made of a biodegradable raw material, and the molded product of the composition has excellent water resistance and favorable moldability, is free from problems in mechanical characteristics such as strength, and also has a cost advantage.

### TECHNICAL FIELD

The present invention relates to a foamable resin composition, and more specifically, to a foamable resin composition which is biodegradable, good in processibility, and available at low cost, and whose molded product has excellent water resistance, and to a foamed body.

### BACKGROUND ART

Foamable resin molded articles are used for packaging material, cushioning material, thermal insulators, or the like. As raw material for those materials, biodegradable resins or starch have been used instead of polystyrene from the viewpoint of environmental problems and cost.

Reference 1 describes, as a foaming material using starch, a raw material composed of starch containing water, an ethylene-vinyl acetate copolymer, a surfactant, and the like. Because the raw material includes an ethylene-vinyl acetate copolymer, the raw material is still insufficient as far as the environment is concerned.

Reference 2 describes a resin composite material containing a thermoplastic resin, a starch-based material, and an agent for compatibilization. Reference 2 also describes an aliphatic polyester as a resin. In addition, a foamed body using the material is also described. However, there is no detailed description on the composition of the material, the method of foaming, and the like. The foamable resin composition needs the following properties: favorable foaming can be obtained; there is no problem in moldability; and its molded product is excellent in strength, water resistance, and the like. Reference 2 does not sufficiently describe the above-mentioned points.
Reference 1: JP 06-87969 A
Reference 2: JP 2004-2613 A

### SUMMARY OF THE INVENTION

An object of the present invention is to provide, in view of the above-mentioned circumstances, a foamable resin composition in which the whole composition is a biodegradable raw material, and the molded product of the composition has excellent water resistance and favorable moldability is free from a problem of mechanical characteristics such as strength, and also has a cost advantage.

The present invention is based on the following findings that using an aliphatic polyester, preferably an aliphatic polyester having a melting point of 100° C. or higher, as a biodegradable resin, combining the polyester with starch and using water as a foaming agent, a favorable foamed form can be obtained, where the obtained product has excellent characteristics.

That is, the present invention provides a foamable resin composition, including starch, an aliphatic polyester, and water, in which 10 to 40 parts by mass of the water and 10 to 80 parts by mass of the aliphatic polyester are included with respect to 100 parts by mass of the starch.

The foamable resin composition of the present invention preferably further contains 3 to 60 parts by mass of glycerin with respect to 100 parts by mass of the starch.

In the foamable resin composition of the present invention, the melting point of the aliphatic polyester is preferably 100° C. or higher.

The foamable resin composition of the present invention preferably further contains 0.2 to 5 parts by mass of a surfactant with respect to 100 parts by mass of the starch. The surfactant is preferably a nonionic surfactant.

The foamable resin composition of the present invention preferably further contains 0.01 to 2 parts by mass of a cross-linking agent with respect to 100 parts by mass of the starch.

The foamable resin composition of the present invention preferably further contains 0.3 to 10 parts by mass of an inorganic compound with respect to 100 parts by mass of the total amount of the starch and the aliphatic polyester.

Further, the present invention provides a foamed body obtained by foaming the foamable resin composition.

### EFFECTS OF THE INVENTION

According to the present invention, the foamable resin composition mainly contains the starch and the aliphatic polyester that is a biodegradable resin, and hence the whole composition is biodegradable; and the aliphatic polyester mainly foams the starch when water is used as a foaming agent, and hence the aliphatic polyester can be formed into the outer shell of a foamed structure, with the result that the foamed structure has excellent characteristics such as high strength. The above-mentioned effect is remarkably exhibited when the aliphatic polyester is one having a melting point of 100° C. or more. Further, because the aliphatic polyester is used as a biodegradable resin, the foamable resin composition has better water resistance than a composition using a polyvinyl alcohol. Further, after a cross-linking agent is blended with the foamable resin composition of the present invention, the obtained composition has much better water resistance.

### BEST MODE FOR CARRYING OUT THE INVENTION

Hereinafter, the content of the present invention will be specifically described.

The present invention is a foamable resin composition containing starch, an aliphatic polyester, preferably an aliphatic polyester having a melting point of 100° C. or higher, and water.

Examples of the starch used in the foamable resin composition of the present invention include natural starches (unprocessed starches) such as potato starch, corn starch, sweet potato starch, wheat starch, and rice starch, decomposed substances thereof, decomposed amylose and amylopectin, and processed starches. Examples of the processed starches include oxidized starches such as dicarbodylic acid starch, esterified starches such as an acetylated starch, etherified starches such as a carboxymethylated starch, cross-linked starches obtained by treating a starch with acetaldehyde or phosphoric acid, and cationized starches obtained by subjecting a starch to a tertiary amination with 2-dimethylaminoethyl chloride. Of those, natural starches are preferred because they are inexpensive.

The aliphatic polyester used in the present invention is synthesized from a polyhydric alcohol such as ethylene glycol, 1,4-butanediol, and 1,6-hexanediol, and a polybasic acid such as succinic acid and adipic acid. In addition, examples of the aliphatic polyester used in the present invention also include cyclic aliphatic polyesters obtained by using 1,4-cyclohexane dimethanol as a polyhydric alcohol. As those aliphatic polyesters, one having a melting point of 100° C. or higher is preferably used.

In addition, the aliphatic polyester preferably has a melt flow rate (MFR) of 8 g/10 min. or lower at 190° C., and more preferably 5 g/10 min. or lower. When the aliphatic polyester has a lower MFR, the strength of a foamed body is improved.

It is preferred that an aliphatic polyester having a branched molecular structure be used, because the foaming ratio can be increased, and a foamed cell easily forms a closed foam, with the result that the strength of the foamed body is further improved. The branched aliphatic polyester is obtained by a copolymerization of a polyhydric alcohol and a polybasic acid, at least one of which has three or more functional groups. For example, the branched aliphatic polyester is obtained by a copolymerization of trimethylpropane, succinic acid, and adipic acid.

In the present invention, when water is used as a foaming agent, only starch is foamed at around 100° C. without foaming an aliphatic polyester, whereby a molded article can be formed, with the result that characteristics such as strength can be enhanced. In particular, when an aliphatic polyester having a melting point of 100° C. or higher is used, the above effect is remarkably exerted.

In the foamable resin composition of the present invention, 10 to 80 parts by mass of the aliphatic polyester are blended with respect to 100 parts by mass of the starch (when water is contained in the starch, the water is not included). When the content of the aliphatic polyester is less than 10 parts by mass, the foamed structure of the obtained molded article is not favorable, and its characteristics such as strength become inferior. On the other hand, when the content of the aliphatic polyester is more than 80 parts by mass, the proportion of the starch decreases, resulting in increased cost of the composition.

The foamable resin composition of the present invention contains water as a foaming agent. The water mainly plays a role in foaming the starch. In order to obtain a favorable foamed body, 10 to 40 parts by mass of water is needed with respect to 100 parts by mass of the starch. It should be noted that the amount of water includes that of water in the starch. That is, the amount of the water is the sum of water added and the water included in the starch.

It is preferred that glycerin be added to the foamable resin composition of the present invention. The glycerin plays a role in enhancing processibility and flexibility of the composition and increasing the stretch of a molded product. It is preferred that 3 to 60 parts by mass of the glycerin be added with respect to 100 parts by mass of the starch. When the content of the glycerin is less than 3 parts by mass, the above-mentioned effects may not be sufficiently obtained. On the other hand, when the content of the glycerin is more than 60 parts by mass, the composition may become sticky, and hence handling the composition may become difficult and the cost of the composition is increased.

It is preferred that a surfactant be added to the foamable resin composition of the present invention for further enhancing processibility. As the surfactant, any of anionic surfactants, cationic surfactants, and nonionic surfactants can be used, and nonionic surfactants are preferred.

Examples of the nonionic surfactant include fatty acid esters such as sorbitan fatty acid esters, propylene glycol fatty acid esters, polyethylene glycol fatty acid esters, and polyoxyethylene sorbitan fatty acid esters and water-soluble polymers such as polyethylene glycol alkyl ether, polyvinyl alcohol, and polyethylene oxide. Of those, sorbitan fatty acid ester is particularly preferred.

The mixture of a liquid surfactant and a powder surfactant before use contributes to improvement of the dispersibility of the surfactant.

The addition amount of the surfactant may be determined depending on the amount of the starch, and is preferably 0.2 to 5 parts by mass, and more preferably 0.5 to 3 parts by mass, with respect to 100 parts by mass of the starch. When the content of the surfactant is less than 0.2 part by mass, processibility may not be sufficiently improved. On the other hand, when the content of the surfactant is more than 5 parts by mass, the kneaded composition tends to be slippery. For example, when the composition is extruded with a twin screw extruder, extruding efficiency may decrease.

A cross-linking agent may be added to the foamable resin composition of the present invention. The addition of the cross-linking agent contributes to the enhanced water resistance of the molded product (for example, the degree of weight loss is reduced in hot water at 80° C.), though the mechanism of the cross-linking is not determined.

Examples of the cross-linking agents include compounds having two or more functional groups such as an epoxy group, a silanol group, an isocyanate group, and an amino group. Specific examples of the cross-linking agent include 2-(3,4-epoxycyclohexyl)ethyltrimethoxysilane, 3-glycidoxypropylmethyldiethoxysilane, 3-glycidoxypropyltriethoxysilane, 3-isocyanatopropyltriethoxysilane, N-2-(aminoethyl)-3-aminopropylmethyldimethoxysilane, 3-aminopropyltriethoxysilane, and polyfunctional isocyanate (for example, COLONATE L, COLONATE HL, COLONATE 2030, AQUANATE 100, AQUANATE 105, and AQUANATE 120, manufactured by NIPPON POLYURETHANE INDUSTRY CO., LTD.)

The addition amount of the cross-linking agent is preferably 0.01 to 2 parts by mass with respect to 100 parts by mass of the starch. When the content of the cross-linking agent is less than 0.01 part by mass, the cross-linking may not be sufficiently performed. On the other hand, the addition of more than 2 parts by mass of the cross-linking agent is meaningless.

A powdered inorganic compound may be added to the foamable resin composition of the present invention. The powdered inorganic compound plays a role in improving the strength of the foamed body by making foamed cells very small. Specific examples of the inorganic compound include titanium oxide, talc, calcium carbonate, and egg shell.

The addition amount of the powdered inorganic compound is preferably 0.3 to 10 parts by mass, and more preferably 1.0 to 3 parts by mass, with respect to 100 parts by mass of the total amount of the starch and the aliphatic polyester. When the content of the powdered inorganic compound is less than 0.3 part by mass, the size of the foamed cells tend to be larger. On the other hand, even when the content of the powdered inorganic compound is more than 10 parts by mass, homogenization of the foamed cells may not be improved.

The particle size of the powdered inorganic compound is not particularly limited, and a particle size commonly used for a resin composition may be applied.

In addition, known additives such as plasticizers, stabilizers, antioxidants, UV absorbers, colorants may be added to the foamable resin composition of the present invention as required. Examples of the plasticizer include ethylene glycol, propylene glycol, polyethylene glycol, and polypropylene glycol.

In the present invention, the method of mixing the aliphatic polyester, starch, water, and glycerin, surfactant, cross-linking agent, and inorganic compound that are added if required, is not particularly limited. The foamed body according to the present invention can be generally produced as follows: an aliphatic polyester, water, powdered starch, and glycerin, surfactant, cross-linking agent, and inorganic compound that are added if required, are preliminarily mixed with a Henschel mixer or the like; the mixture is then heated and melted under pressure to be extruded while being foamed from a die having a desired shape with an extruder, and the foamed body is directly obtained; and the foamed body is cut to be discrete foamed bodies. In addition, the foamed body according to the present invention can also be produced as follows: an aliphatic polyester, starch, water, and glycerin, a surfactant, a cross-linking agent, and an inorganic compound that are added if required, are mixed with a Henschel mixer or the like; the mixture is then heated and melted under pressure under the conditions in which the foaming is not caused by an extruder to obtain a strand from a die; the strand is cut into pellets; the pellets are loaded, for example, into an extruder at a different place; and the pellets are heated at high temperature and melted under pressure to be extruded from a die having a desired shape, whereby the foamed body can be obtained. Further, the foamed body according to the present invention can also be produced as follows: an aliphatic polyester, starch, water, and glycerin, a surfactant, a cross-linking agent, and an inorganic compound that are added if required, are mixed with a Henschel mixer or the like; water is charged into an extruder when the mixture is kneaded with the extruder; and the mixture is extruded while being foamed from a die having a desired shape, whereby the foamed body can be obtained. Thus, the foamable resin composition of the present invention includes, in addition to a composition to which water is preliminarily added, a composition to which water is added while kneading is performed in an extruder. Moreover, the following can be performed: after pellets blended with a component other than water are obtained, the pellets are impregnated with water, and the resultant is foamed to be foamed pellets; or pellets obtained under the conditions in which the pellets containing water are not foamed or pellets obtained by being impregnated with water later are formed into various foamed molded articles by using a mold. The foamable resin composition of the present invention thus also includes a composition obtained by impregnating pellets with water later as described above. The foamable resin composition of the present invention can be formed into a foamed molded article, and can be suitably used as a cushioning material after being formed into a discrete foamed body.

It is preferred that the heating temperature at the time of molding be generally near the melting point of an aliphatic polyester, and it is specifically in the range of 100 to 120° C.

The shape and application of the molded product using the foamable resin composition of the present invention are not particularly limited. The foamable resin composition of the present invention can be molded into sheets, films, containers, or the like by using extrusion molding, blow molding, mold-foaming molding, injection molding, or the like.

### EXAMPLES

Hereinafter, the present invention will be specifically described by way of examples, and the present invention is not limited to the examples.

The following raw materials were used in the examples.

Starch: raw corn starch (manufactured by Oji Cornstarch Co., Ltd., product name: Raw Corn Starch, moisture content: about 8.5% by mass)

Aliphatic polyester: BIONOLLE #1001 (melting point: 115° C.) manufactured by SHOWA HIGHPOLYMER CO., LTD., BIONOLLE #1010 (melting point: 115° C.) manufactured by SHOWA HIGHPOLYMER CO., LTD., BIONOLLE #1903 (melting point: 115° C.) manufactured by SHOWA HIGHPOLYMER CO., LTD., BIONOLLE #3001 (melting point: 90° C.) manufactured by SHOWA HIGHPOLYMER CO., LTD.

Polyvinyl alcohol: GOHSENOL NM-11 manufactured by Nippon Synthetic Chemical Industry, Co., Ltd.

Glycerin: general commercial product

Surfactant: glycerol monostearate (nonionic surfactant)

Cross-linking agent: 3-isocyanate propyl triethoxy silane

Inorganic compound: Talc was used in Examples 1 and 2, egg shell in Example 5, calcium carbonate in Examples 3 and 4, and powdered seashell in Examples 6 and 7. The average particle diameter (measured by a laser method) is about 10 μm.

The above-mentioned raw materials were mixed by using a Henschel mixer in the ratio described in Table 1, and the mixture was subjected to foam molding using a co-rotating twin screw extruder. The amount of water in the table is the sum of added water and water included in the starch. Molding gave a cylindrical foamed molded article (the diameter of the molded article was about 15 mm in Examples 1 to 7, 9, 10, and 12, and was about 40 mm in Examples 8 and 11). The cylinder temperature at the time of molding was set to 115° C. in Examples 1 to 6 and 8 to 12, 110° C. in Comparative Example 1, and 180° C. in Comparative Example 2. In addition, the die temperature was set to 160° C. in Examples 1 to 8 and Comparative Example 1, and 190° C. in Comparative Example 2.

In example 7, pellets were produced at a cylinder temperature of 115° C. and a die temperature of 90° C., and the obtained pellets were then formed into a cylindrical foamed body using a single screw extruder at a cylinder temperature of 90° C. and a die temperature of 160° C.

The water resistance was evaluated for changes in appearance of the molded article when a part of the molded article was soaked in water at 25° C. or hot water (80° C.) for 1 hour. The molded article whose appearance did not virtually change is indicated as “∘”, and the molded article whose surface was destroyed or whose surface shape was not maintained is indicated as “x”.

TABLE 1

| | | Example | | | | | | |
|---|---|---|---|---|---|---|---|---|
| | | 1 | 2 | 3 | 4 | 5 | 6 | 7 |
| Starch [parts by mass] | | 100 | 100 | 100 | 100 | 100 | 100 | 100 |
| BIONORE #1001 [parts by mass] | | 45 | 45 | 40 | | 50 | 50 | 45 |
| BIONORE #1010 [parts by mass] | | | | | | | | |
| BIONORE #1903 [parts by mass] | | | | | 40 | | | |
| BIONORE #3001 [parts by mass] | | | | | | | | |
| Polyvinyl alcohol [parts by mass] | | | | | | | | |
| Water [parts by mass] | | 25 | 18 | 25 | 20 | 27 | 32 | 25 |
| Glycerin [parts by mass] | | | 10 | 10 | 10 | | | |
| Surfactant [parts by mass] | | | | 0.5 | 0.5 | 0.5 | 1 | 1 |
| Cross-linking agent [parts by mass] | | | | | 0.5 | | 0.3 | |
| Inorganic compound [parts by mass] | | 1.5 | 1.5 | 2 | 2 | 2.5 | 2.5 | 3 |
| Evaluation | Specific gravity of | 0.07 | 0.05 | 0.06 | 0.02 | 0.06 | 0.08 | 0.07 |
| | molded product | | | | | | | |
| | Hot water test | x | x | x | ∘ | x | ∘ | x |
| | 25° C. water test | ∘ | ∘ | ∘ | ∘ | ∘ | ∘ | ∘ |
| | | | | | | | Comparative | |
| | | | | | | | Example | |
| | | 8 | 9 | 10 | 11 | 12 | 1 | 2 |
| Starch [parts by mass] | | 100 | 100 | 100 | 100 | 100 | | 100 |
| BIONORE #1001 [parts by mass] | | | 15 | | | | | |
| BIONORE #1010 [parts by mass] | | | | | | 45 | | |
| BIONORE #1903 [parts by mass] | | | | 10 | | | | |
| BIONORE #3001 [parts by mass] | | 50 | | | 20 | | 100 | |
| Polyvinyl alcohol [parts by mass] | | | | | | | | 50 |
| Water [parts by mass] | | 20 | 20 | 20 | 25 | 25 | 20 | 25 |
| Glycerin [parts by mass] | | | 10 | | | | | |
| Surfactant [parts by mass] | | | 0.5 | 0.5 | 1 | 0.5 | | |
| Cross-linking agent [parts by mass] | | | 0.5 | 0.5 | | 0.5 | | |
| Inorganic compound [parts by mass] | | | 2 | 2.5 | 2 | 2 | | |
| Evaluation | Specific gravity of | 0.04 | 0.04 | 0.08 | 0.06 | 0.06 | Not | 0.08 |
| | molded product | | | | | | foamed | |
| | Hot water test | x | ∘ | ∘ | x | ∘ | | |
| | 25° C. water test | ∘ | ∘ | ∘ | ∘ | ∘ | | x |

The foamed bodies in Examples 1 to 7 and 9 to 12 had smaller foamed cells than the foamed body in Example 8, and were foamed bodies that were more homogeneous.

As described above, the foamable resin composition of the present invention mainly contains a biodegradable starch and a biodegradable resin, and hence it can be formed into a product that is environmentally friendly. Also, the foamable resin composition of the present invention has good processibility, and its molded article is excellent in strength, water resistance, and the like. Thus, the foamable resin composition of the present invention is suitable for foamed sheets, cushioning material, packaging material, thermal insulators, or the like.

1. A foamable resin composition comprising starch, an aliphatic polyester and water, wherein 10 to 40 parts by mass of the water and 10 to 80 parts by mass of the aliphatic polyester are included with respect to 100 parts by mass of the starch.

2. A foamable resin composition according to claim 1, further comprising glycerin.

3. A foamable resin composition according to claim 2, wherein 3 to 60 parts by mass of the glycerin are included with respect to 100 parts by mass of the starch.

4. A foamable resin composition according to claim 1, wherein a melting point of the aliphatic polyester is 100° C. or higher.

5. A foamable resin composition according to claim 1, further comprising a surfactant.

6. A foamable resin composition according to claim 5, wherein the surfactant is a nonionic surfactant.

7. A foamable resin composition according to claim 5, wherein 0.2 to 5 parts by mass of the surfactant are included with respect to 100 parts by mass of the starch.

8. A foamable resin composition according to claim 1, further comprising a cross-linking agent.

9. A foamable resin composition according to claim 8, wherein 0.01 to 2 parts by mass of the cross-linking agent are included with respect to 100 parts by mass of the starch.

10. A foamable resin composition according to claim 1, further comprising 0.3 to 10 parts by mass of an inorganic compound with respect to 100 parts by mass of a total amount of the starch and the aliphatic polyester.

11. A foamed body obtained by foaming the foamable resin composition according to claim 1.
